(19) United States
(12) Patent Application Publication
(10) Pub. No.: US 2010/0042230 A1
(43) Pub. Date: Feb. 18, 2010

(54) METHOD AND DEVICE TO MANAGE AN OBJECT AND PARTS THEREOF

(75) Inventor: Urmas Tangsoo, Peetri Kula (EE)

Correspondence Address: YOUNG & THOMPSON, 209 Madison Street, Suite 500, Alexandria, VA, 22314, US

(73) Assignees: URMAS TANGSOO, Peetri Kula (EE); MIROVAR OÜ, Viimsi Alevik (EE)

(21) Appl. No.: 11/917,949

(22) PCT Filed: Jun. 6, 2006
(86) PCT No.: PCT/EE2006/000005

§ 371 Date: Feb. 6, 2009

(30) Foreign Application Priority Data
Jun. 21, 2005 (EE) P200500019

(51) Int. Cl. G05B 19/05

(52) U.S. Cl. 700/7; 700/14

(57) ABSTRACT

A method and device for connecting electrical and electronic devices into integrated network. The device includes monofunctional computer, i.e. programmable controller and actuator controller, and two information channels or networks. Via the inner network takes place the exchange of information between the programmable controller and the actuator controller. Inner network can be: alternate current electricity network, separate low voltage cable network, radio communication network. Public internet, via which are changed system parameters of the programmable controller via WEB interface and secured information on the object for the system operator. Via the internet into the programmable controller are downloaded software updates from the software service server of the operator and software modules of the new applications of the controller of the effective device. Updating of the nodes and controlling elements of the device are done in real-time.

### TECHNICAL FIELD

This invention concerns the practical applications accompanying Internet that are integrated into one complete system in managing a building and/or territory. The main users of the system would be real estate developers and managers, private sector, medicine, security companies, companies owning industrial electronics, children's institutions, schools etc.

For a broader clientele the Internet today is mostly an environment to get and intermediate information. Only a very narrow segment of the Internet is being used for managing, starting, analyzing certain processes, for changing equipment parameters or for using functions used in telemetry. All this together could be an applicable Internet—activities that the customer can perform independently by operating the equipment managed by him over the Internet channel.

The equipment and systems are used in very many fields at the moment that have a certain function to fulfill and their parameters can be changed or managed over the Internet. The equipments of the companies in different fields are usually not compatible with each other and they have no possibilities to connect the different equipment or systems into one logical system.

For example, if it would be necessary in an apartment building or office building to connect heat electronics system, security system, access system, domestic electronics and household appliances, lighting etc., it would be necessary to have at least three to four controllers and every system would need its own cabling. Intervention of a specialist of a specific field is also necessary when setting up each controller.

### STATE OF THE ART

In patent EP 1 217 475 is disclosed only the system to be used in a household (switching equipment on/off and inspection of the state of the equipment), where the logical connections are made directly by a person.

In patent JP2002152858 automating system of a building is disclosed, which enables to add new domestic appliances and to operate these automatically. The system contains home appliances, controller that is connected with server and through which a screen will be opened for the customer to operate or control home appliances.

### SUMMARY OF THE INVENTION

This invention provides a method and device to combine electrical and electronic equipment produced by different producers into one unitary solution, through which the data is being collected and analyzed in a room or territory and processes are being managed. Direct intervention of a person to a process is not primary.

In the case of the technical solution offered by this invention it is possible to integrate different equipment, sensors or actuators into one multifunctional system, where each appliance has its own certain function or sequence-logics of the circuit in the system. Such system enables to save time, labor, number of different cabling and the most important—investments when implementing the equipment.

The main components of the device related to the invention are monofunctional computer, the programmable controller and the controller of the effective equipment, which has an effective equipment/circuit attached to or integrated into it. The whole device contains two information channels or networks, which are divided: public Internet, which is the medium to change the programmable controller system parameters through WEB interface and to provide information to the system operator in the object. Software improvements and the modules of new actuator controller application software are being loaded into programmable controller from the server of operator software services through the Internet. Renewal of the nodes and control device of the appliance is performed in real time.

The object contains an intranet, which is the medium of exchanging of information between the programmable controller and the actuator controller and all actuator controllers in the intranet of the object get their power through this network. For this purpose it is probably the most optimal to use the power network of alternating current 110/220V, but the use of low-voltage cable (network) cannot be excluded as a carrier of information and for the power supply to the equipment. It is also possible to use a radio connection or radio connection networks to transfer information, however, in this case the actuator controllers must be in an autonomic power supply. The plus of the power networks of alternating current is the fact that most of the existing in-building power network cabling can be utilized.

### LIST OF FIGURES

A more complete view of this invention can be obtained by reading the following detailed description of the design example with the attached figures where:

FIG. 1 depicts a general conception and operating principal of the method,

FIG. 2 depicts the circuit diagram of the programmable controller,

FIG. 3 depicts the circuit diagram of the actuator controller,

### DETAILED DESCRIPTION OF THE INVENTION

FIG. 1 depicts a general operating principal of the favorable implementation version of the method. The device contains at least one programmable controller 1, at least one actuator controller 2, a software service server 3. Programmable controllers 1, at least one is included, are connected to the in-building distribution network (hereinafter intranet) 4, which is a circuit system or a star system. Programmable controllers 1 are mutually synchronized and duplicate each other. If the first programmable controller stops working the second programmable controller assumes the functions of the first one. The connection with a public Internet 5 is IP-based and each programmable controller 1 has its own static IP. The hierarchical system upon building the network of programmable controller 1 will be specified when adjusting the intranet.

The function of the software service server 3 is to share software modules 6 of the equipment of the new developed actuator controllers 2, also the software reformations and improvements on the programmable controllers 1 and the actuator controllers 2. In the case of each registered programmable controller 1 that connects into the Internet 5, all the improvements will be loaded to the programmable controller 1, and the software service server 3 also enables to make regular copies of the configuration of each programmable controller 1 to its data carrier. The software service server 3 provides the system the service of software improvements and backup copies of the configuration. The software as a whole includes the software modules 15, of which the programmable controller 1 makes a logical system according to its intranet requirements.

Upon utilization of each equipment group of the actuator controller 2 a software module 6 characterizing an equipment or equipment group of the actuator controller 2 will be issued by the software service server 3. Basically, there are eight main groups of equipment of the actuator controller 2.
1) actuator controllers measuring the voltage,
2) actuator controllers regulating the voltage,
3) actuator controllers measuring the level,
4) actuator controllers issuing the level,
5) actuator controllers measuring the duration of an impulse or impulses,
6) actuator controllers changing the duration of an impulse or the frequency of an impulse,
7) actuator controllers transferring multi media,
8) actuator controller modulating or removing the binary code.
   The number of more specific main groups of the actuator controllers is substantially longer.

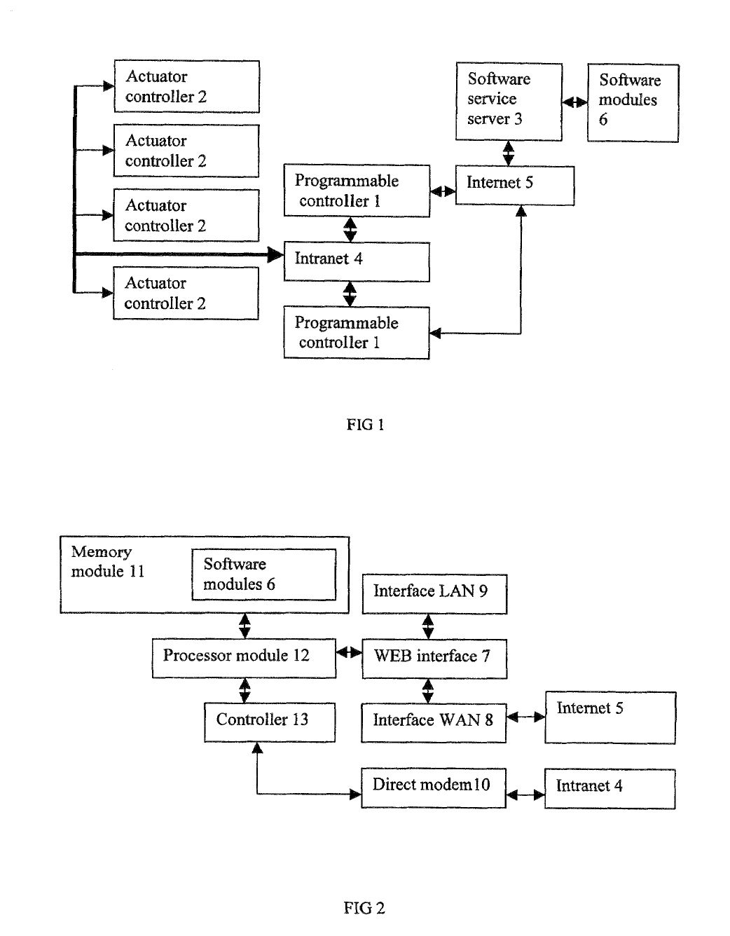

The operation of the intranet 4 is regulated by the first programmable controller 1, which is questioning consecutively all the actuator controllers 2 and upon receiving an understandable response from an actuator controller 2 being questioned the next actuator controller 2 will be questioned. There will be pauses made in the questioning circuits, where the scanning of the new actuator controllers 2 connected to the networks is carried out as well as the synchronization with other programmable controllers 1 in the intranet 4. If a new actuator controller 2 was discovered during the scanning, a device that gives a programmable controller 1 its unique code, which software module 6 it needs for operating, the corresponding module 6 from the software service server 3 will be loaded to the programmable controller 1 and the administrator managing the system will be notified of the new module of the actuator controller 2. If a similar software module 6 was already loaded into the programmable controller 1, there will not be any downloading and the system administrator may describe a certain module of the actuator controller 2 for the network through WEB interface 7 (see FIG. 2), i.e. give to the actuator controller 2 specific parameters and set the actuator controller 2 to a logical connection in the intranet. The whole idea of an intranet 4 is simple—each actuator controller 2 would perform its function and turn an object (house, apartment building, office building etc.) into one complete solution and save costs of the consumer and the owner.

### Service Logics

Service logic is a result of the described method, where the equipment's: information collection, analysis and circuits can result a chain of logical functions for a Person or Processes, and consequently the service logics is created.

Let's make an example: When an employee enters into an office building and identifies himself, he will receive pre-programmed specific access rights; the operation of the locks will be controlled; the security sensors and cameras of certain rooms, where the employee has the right to be, will be switched off; the lights of the rooms will be switched on; and the air-conditioner of the room will be switched from the saving mode to the normal temperature mode. This means that a numerous necessary circuits will be made to improve the well-being of an employee and also to improve his working conditions. Upon entering into an office building, an employee practically does not have to switch anything on or off that is usually a routine procedure to prepare an office space for work; all this will be carried out in a centralized way according to corresponding software. This mechanism is also engaged when an employee leaves the office building. The air-conditioner will be switched into the saving mode, unnecessary lighting will be switched off; necessary security equipment and cameras will be switched on, etc. At the same time the total time the employee was in the building will be recorded, also his moving trajectory, etc. This information can be used when designing a record-keeping of work-time and organizing a better work planning.

For each consumer, employee or customer it is possible to create a service logics package that considers the needs of a certain person in a specific object.

The benefit is very versatile. Convenient service for an employee or customer in an office building, saved power and central heating energy, statistics necessary for an employer about employees or customers etc. Such a solution is especially convenient on the objects, where customers/lessees change constantly, rebuildings, system alterations etc. are carried out. Such a flexible solution, where the equipment of intranet—the actuator controllers 2 must be always transposed, change their location and function in the network and parameters, gives a remarkably great economic effect and saved time.

FIG. 2 describes the block diagram of the programmable controller 1. The device has three main interfaces. Internet interface WAN 8, local computer network interface LAN 9 and intranet direct-connect modem 10 with the actuator controllers 2 and other programmable controllers 1 in the intranet to exchange information.

Presumption of the normal functioning of the programmable controller 1 is the direct connection of the Internet 5, where the constant network parameters of the Internet have been assigned to the programmable controller 1. Information exchange in the Internet goes through WAN port 8 to the firewall built into the programmable controller 1, where the filtration of IP and MAC addresses, information encryption and identification of the device administration is carried out, if necessary.

Computer network port LAN 9 is intended for establishing a local computer network by using the existent firewall and for administrating the system immediately by the programmable controller 1.

The user interface 7 (WEB browser window) of the programmable controller also consists of the hyperlink system, where upon adding a software module 6 of the actuator controller 2 from the service server 3 a necessary hyperlink is added to the WEB user interface 7.

In relation with WEB user interface 7, it is important that finding the necessary link would be easy and logical. Configuration of all the equipment in the system must be also extremely simple, understandable and visualized. In order for each literate person would be able to enter or change the necessary parameters.

All activities performed in the system will be saved in the memory module 11 of the programmable controller in the chronological order, which forms a log file of the system. Also the software modules 6 of the actuator controller 2, parameters of the system equipment and other data and variable values necessary for system operation are located there.

The processor module 12 is the heart and coordinator of the whole system. The process module 12 of the programmable controller 1 has an internal, synchronizable from the Internet 5, clock, calendar and timer. The processor module 12 analyzes data and organizes the work of the whole system on the basis of the pre-set parameters, criteria and logics.

The controller module 13 of the equipment of the programmable controller 1 is an interface, where the preparation and interchanging of information to the equipment of the actuator controller 2 of the intranet 4 is carried out. This means: coding and decoding of data, orders, inquiries etc. and out-filtering the information noise formed in the intranet 4. The controller module 13 of the programmable controller 1 serves as a bridge between the processor module 12 and the direct-connect modem 10 of the intranet 4.

Data transfer of the programmable controller 1 to the actuator controllers 2 is carried out through the direct-connect modem 10 of the intranet. The direct-connect modem 10 has a certain intranet protocol and is galvanically disconnected from the intranet cable. The connection is either inductive of optical. By this the possibility to disable the system will be minimized. The possibilities to disable the system would be the following: short-circuit, creating noise in the intranet 4, excess voltage, high-potential static electrical charge, etc. In order to decrease this risk, it would be beneficial to use round cable system. If the round cable system is cut off, the inquiry or response will most likely still reach the actuator controller 2. In order to decrease the industrial noise, it is reasonable to use the principle of Sweep signal, where a useful signal is modulated in a wide frequency band or in the case of the noise it will be connected to the next carrier frequency. This ensures that even if any frequency or frequency range is interfered, it probably does not affect transferring the useful signal in the network.

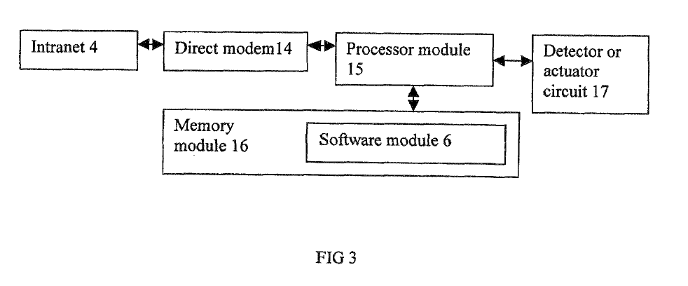

FIG. 3 depicts the actuator controller 2 with the main module being direct-connect modem 14 as does the programmable controller 1. It is practical to use the created inductive energy also as the power supply for the actuator controller 2. However, such a solution presumes using components with a very little power consumption and a low voltage in the circuits. Technical solution is still determined by the prototype design phase. The operation of the direct-connect modem 14 is controlled by the process module 15 with the memory modules 16 and the last circuit in the actuator controller 2 is the module of the detector or actuator circuit 17. This circuit with the software module 6 in the memory module 16 of the process module determines the function of the actuator controller.

1-10. (canceled)

11. Method to manage an object and parts thereof, where the object comprises equipment and systems that have a certain function to fulfill and their parameters are changed or managed over the Internet, comprises the following steps:
programmable controllers (1), at least two are included, are connected with each other;
programmable controllers (1) are synchronized;
programmable controllers (1) are set to duplicate each other;
programmable controllers (1) are connected into intranet (4);
programmable controllers (1) are connected with the public Internet (5) on the basis of Internet Protocol (IP);
by at least one software service server (3) are shared software modules (6) of the equipment of the new developed actuator controllers (2) to the programmable controllers (i);
programmable controller (1) is configured to communicate for data exchange consecutively with all the actuator controllers (2),
updates and improvements of the programmable controllers (1) and the actuator controllers (2) are shared with the software service servers (3);
the system administrator is configured to describe the module of certain actuator controller (2) for the network through the Internet interface (7) and to give to the actuator controller (2) specific parameters and to set the actuator controller (2) into the logical circuit in the intranet, characterized in that the programmable controller (1) is configured to form from the software modules (6) a logical system of the functions of the actuator controllers (2) corresponding to the requirements of the intranet (4), where one and the same actuator controller (2) can have different function at the different time depending of the user profile of the software module (6).

12. Method according to claim 11, characterized in that the different user profiles of the software module (6) are programmed by the programmable controller (1) and/or by the software service servers (3).

13. Method according to claim 11, characterized in that the synthesized rules in real time are drafted from the different user profiles of software modules (6).

14. Method according to claim 13, characterized in that the user profiles include: sequence of the logical functions (service logics packet) for human, sequence of the logical functions (service logics packet) for processes.

15. Method according to claim 11, characterized in that the software improvements and the backup copies of the intranet (4) devices including programmable controller (1) and actuator controller (2) are carried out by the software service server (3).

16. Method according to claim 11, characterized in that includes a step where by the programmable controllers (1) is carried out the scanning according to the predetermined algorithm of the new actuator controllers (2) connected to the network, and the synchronization with other programmable controllers (1) and software service servers (3) in the intranet (4).

17. Method according to claim 11, characterized in that by the actuator controller (2) following functions are implemented:
measuring the voltage,
adjusting the voltage,
measuring the logical level,—outputting the logical level,
measuring the duration of an impulse or the frequency of an impulse,
changing the duration of an impulse or the frequency of an impulse,
transmitting multimedia signals,
modulating or transmitting the binary code.
